(19) United States
(12) Patent Application Publication
(10) Pub. No.: US 2026/0066141 A1
(43) Pub. Date: Mar. 5, 2026

(54) NUCLEAR REACTOR THERMAL MANAGEMENT SYSTEM

(71) Applicants: ABILENE CHRISTIAN UNIVERSITY, Abilene, TX (US); GEORGIA TECH RESEARCH CORPORATION, Atlanta, GA (US); The Texas A&M University System, College Station, TX (US)

(72) Inventors: Jonathan Scherr, Abilene, TX (US); Timothy Head, Abilene, TX (US); Mark Kimber, College Station, TX (US); Rusty Towell, Abilene, TX (US); Steven Biegalski, Atlanta, GA (US); Jack Shoemate, Abilene, TX (US)

(21) Appl. No.: 19/259,585

(22) Filed: Jul. 3, 2025

Related U.S. Application Data
(63) Continuation of application No. 19/038,162, filed on Jan. 27, 2025.
Application No. 19/038,162 is a continuation of application No. 18/450,884, filed on Aug. 16, 2023.
(60) Provisional application No. 63/399,593, filed on Aug. 19, 2022.

(51) Int. Cl. G21C 9/016; G21C 3/54; G21C 11/08; G21C 15/18

(52) U.S. Cl. CPC G21C 9/016; G21C 3/54; G21C 11/081; G21C 11/083; G21C 15/182

(57) ABSTRACT

Disclosed is a reactor thermal management system. A molten salt reactor vessel and a second component (e.g., a drain tank) fluidly coupled with the molten salt reactor vessel are configured to receive a flow of a molten salt therewith. The reactor thermal management system includes an internal shield or vessel encompassing the molten salt reactor vessel and the second component, the internal shield or vessel defining a first thermally insulative region therein. The internal shield or vessel is configured to maintain the first thermally insulated region above a melting temperature of the molten salt during operation of the molten salt reactor vessel.

### CROSS-REFERENCE TO RELATED APPLICATIONS

The present application claims priority under 35 U.S. C. § 119 to U.S. Provisional Application No. 63/399,593, entitled “REACTOR THERMAL MANAGEMENT SYSTEM,” filed Aug. 19, 2022, the entirety of which is incorporated by reference herein.

### TECHNICAL FIELD

The described examples relate generally to systems, devices, and techniques for maintaining and controlling temperatures associated with components of a nuclear reactor.

### BACKGROUND

A fuel salt is a salt that contains fissionable material (such as enriched uranium). A molten salt reactor is a system capable of inducing a fission reaction in a molten fuel salt within a reactor vessel. Molten salt reactor systems commonly utilize a drain tank or dump tank as well as a heat exchanger, pump, and expansion tank in a closed loop system or in “pool” type reactors. These components may be heated and insulated external to the piping. Inadvertent spilling of the fuel salt, whether caused by operator error or rupture of the reactor system, is a major accident. In current designs if molten salt leaks out of the insulated jacket and into a lower temperature enclosed air space, the salt will cause the air to heat up resulting in a pressure spike inside the enclosure which can potentially cause a more severe accident.

Therefore, there is a long-felt, but unresolved need for a heated apparatus or system to contain any molten fuel salt that escapes the reactor system and prevent the molten fuel salt from interacting with other non-heated components, while providing heating and insulation to the necessary components.

### SUMMARY

In one example, a system is disclosed. The system includes a molten salt reactor vessel. The system further includes a second component (e.g., a drain tank) fluidly coupled with the molten salt reactor vessel and configured to receive a flow of a molten salt therewith. The system further includes an internal shield or vessel encompassing the molten salt reactor vessel and the second component, and which defines a first thermally insulative region therein. The internal shield or vessel is configured to maintain the first thermally insulated region above a melting temperature of the molten salt during operation of the molten salt reactor vessel.

In another example, the system may include an insulative material or fluid defining an insulative barrier about the first thermally insulative region.

In another example, the insulative material may include a polytetrafluoroethylene.

In another example, the fluid may include an inert gas held under vacuum. The inert gas may be releasable through a fail-open vent upon a shutdown of the molten salt reactor system.

In another example, the second component may include a drain tank. In some cases, the system may further include a third component fluidly coupled to the molten salt reactor vessel and the drain tank. The third component, the molten salt reactor vessel, and the drain tank may define a loop therewith for continuous circulation of the molten salt during operation of the molten salt reactor. Further, the system may include a reactor enclosure encompassing the internal vessel and the third component therein.

In another example, the reactor enclosure may define a second thermally insulative region. The second thermally insulative region may be held at a temperature that is cooler than a temperature of the first thermally insulative region.

In another example, one or both of the internal shield or vessel and the reactor enclosure are formed from a stainless steel material configured to withstand temperatures in excess of 600 ° C.

In another example, the system may further include a concrete structure that defines a trench. The reactor enclosure may be received within the trench. The concrete structure and the reactor enclosure may define a third thermally insulative region therebetween. The third thermally insulative region may be held at a temperature that is cooler than a temperature of the second thermally insulative region.

In another example, the third component may include a reactor access vessel. The system may further include a molten salt pump and a heat exchanger. Each of the molten salt pump and the heat exchanger may be fluidly coupled with the molten salt reactor vessel, the drain tank, and the reactor access vessel along the loop.

In another example, the internal shield or vessel further encompasses at least a portion of the reactor access vessel, the molten salt pump, and the heat exchanger.

In another example, the system further includes a liner arranged below both the molten salt reactor vessel and the second component and being configured to receive a quantity of the molten salt in response to a leak event.

In another example, a reactor thermal management system (RTMS) is disclosed. The RTMS includes an internal shield or vessel configured to encompass and thermally insulate a plurality of molten salt holding components of a molten salt loop. The RTMS further includes a reactor enclosure encompassing the internal shield or vessel the molten salt loop. The internal shield or vessel defines a first thermally insulative region about the plurality of molten salt holding components. The reactor enclosure defines a second thermally insulative region about the internal shield or vessel. The RTMS may be configured to maintain the first thermally insulative region at a higher temperature than the second thermally insulative region.

In another example, the RTMS may be configured to maintain the first thermally insulative region at a temperature of excess of 600° C.

In another example, the RTMS may include an insulative material or fluid along a surface of the internal shield or vessel.

In another example, the RTMS further includes a concrete structure that defines a trench. The internal shield and the reactor enclosure may be disposed in the trench and encompassed by the concrete structure.

In another example, the concrete structure includes a top piece that closes the internal shield or vessel and the reactor enclosure within the trench. The concrete structure and the reactor enclosure may define a third thermally insulative region therearound. The third thermally insulative region may be held at a temperature that is cooler than a temperature of the second thermally insulative region.

In another example, a method of maintaining a temperature of molten salt holding components of a nuclear reactor system is disclosed. The method includes operating a molten salt reactor vessel. The method further includes causing a flow of a molten salt between the molten salt reactor vessel and a second component. The method further includes holding heat of the nuclear reactor system proximal to the molten salt reactor vessel and the second component using an RTMS including an internal shield or vessel.

In another example, the method further includes collecting, by the internal shield, a quantity of the molten salt in response to a leak event.

In another example, the method further includes operating, along a molten salt loop, the molten salt reactor vessel, a drain tank, a reactor access vessel, a molten salt pump, and a heat exchanger. In some cases, the second component includes one of the drain tank, the reactor access vessel, the molten salt pump, or the heat exchanger.

In another example, the method further includes maintaining a temperature of a first thermally conductive region by operating one or more heaters that is thermally coupled to the internal shield or vessel.

In addition to the example aspects described above, further aspects and examples will become apparent by reference to the drawings and by study of the following description.

### BRIEF DESCRIPTION OF THE DRAWINGS

FIG. 1 depicts a schematic representation of an example molten salt reactor system.

FIG. 2 depicts an example reactor thermal management system.

FIG. 3 depicts another example reactor thermal management system.

FIG. 4 depicts the reactor thermal management system of FIG. 3 in a concrete trench.

FIG. 5 depicts a schematic functional diagram of the reactor thermal management system of FIG. 4.

FIG. 6 depicts a cross-sectional view of another example reactor thermal management system, taken along a x-z plane.

FIG. 7 depicts a cross-sectional view of the reactor thermal management system of FIG. 6, taken along a y-z plane.

FIG. 8 depicts a schematic view of a bottom portion of an example reactor thermal management system.

FIG. 9 depicts a cross-sectional view of another example reactor thermal management system including an inert gas insulating layer held under vacuum.

FIG. 10 depicts a concert structure including a trench for enclosure of the vessels of a reactor thermal management system.

FIG. 11 depicts a flow diagram of an example method of maintaining a temperature of molten salt holding components of a nuclear reactor system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

Molten salt reactors may contain molten fuel salt that is enriched with a fissionable material (e.g., uranium) to generate heat. The molten salt fuel should stay above a certain temperature to stay in liquid form, or else it will solidify in the reactor system, which would potentially cause plugging issues and/or other issues in the reactor system, including causing potential mechanical failures in the system. Thus, in many examples, salt-bearing components within the reactor system should be maintained at a temperature at which the fuel salt will not solidify. In some examples, the temperature that the fuel salt should be kept at or above is hotter than other cold-components within the system can operate. Further, the fuel salt contains a significant source of radiation and should be confined and shielded.

The reactor thermal management system (“RTMS”) disclosed herein may surround a reactor vessel, a drain tank, and associated piping (each of these components may be fuel salt bearing) to maintain fuel salt temperature and to retain any fuel salt that leaks from the reactor system components therein. The RTMS may further function to insulate or otherwise define a barrier between the salt-bearing components and those other surrounding components (e.g., a concrete trench, structural steel, and so on) that should be maintained at a temperature that is cooler than the salt-bearing components. In certain examples, the RTMS is an engineered, passive safety system for the molten salt reactor system. For example, the RTMS may include an inner vessel and an outer insulation layer and may be implemented as an integral thermal insulation enclosure that surrounds at least two reactor system components, such as a reactor vessel and a drain tank, each of which are salt-bearing components. Additionally, in at least one example, the RTMS may include one or more heating devices (e.g., resistance heaters) positioned within the outer thermal insulation, or within the RTMS vessel, to heat the reactor vessel, drain tank, and associated piping, and to ensure that any fuel salt that leaks from any of the components within the RTMS will not freeze in the reactor vessel during operation or accident conditions.

In some cases, the RTMS vessel may be made of stainless steel, or some other similar metal that can withstand high temperatures so that the air temperature within the inner vessel may be about 600° Celsius, though the air temperature may be hotter or cooler as long as the temperature is high enough to keep the molten salt in liquid form. In at least one example, the RTMS vessel is kept at the same temperature as the molten fuel salt, or at least above the melting point of the fuel salt, so that if any fuel salt leaks from the components within the RTMS vessel, the RTMS vessel acts as a catch-pan for the molten fuel salt and, upon contact with the RTMS vessel, the molten fuel salt will not cause a pressure spike within the larger reactor enclosure because there is little or no temperature difference between the RTMS vessel wall and the molten fuel salt.

In several examples, the heating devices may be internal within the RTMS inner vessel, or external to the RTMS inner vessel in and/or around the insulation layer. In one or more examples, if the heating devices are internal within the inner vessel, the heating devices may be coils or electrical resistance heaters that provide heat to the general atmosphere and components within the inner vessel, or may directly heat the inner vessel, which would then provide heat to the atmosphere and components within the inner vessel.

In one or more examples, if the heating devices are external to the inner vessel, the heating devices may provide direct heat to the outer surface of the inner vessel, and then the heat transfers to the inner surface of the inner vessel, and ultimately heats the atmosphere and components within the inner vessel.

In one or more examples, the insulation may be thermal insulation used to keep the atmosphere and components within the inner vessel heated while keeping the atmosphere outside the RTMS cool. The insulation layer may be made of polytetrafluoroethylene, but may also be made of other known insulating materials.

Further, the RTMS may be constructed as a fail-safe system for the molten salt reactor system. In many examples, if the molten salt reactor system loses power, the reactor vessel is designed to drain into the drain tank through the piping therebetween. In at least one example, without the RTMS in the molten salt reactor enclosure, the molten fuel salt would freeze in the piping as the reactor vessel drains because the RTMS is not there to heat the piping, which could damage the piping or cause a molten salt to not drain properly, resulting in significant nuclear safety concerns. In certain examples, upon loss of power, the heating devices may shut off, and the RTMS and components within may slowly cool, but the cooldown period is long enough for the molten fuel salt to drain into the drain tank without freezing in the piping (i.e., the temperature within the components and inner vessel remains hot enough so that the fuel salt remains in liquid (molten) form while draining into the drain tank upon loss of power. Additionally, in some embodiments, the inner vessel may withstand, without failure, direct contact of at least 1.5 tons of molten fuel salt or all of the fuel bearing salt falling from the reactor vessel, drain tank or piping and collecting at the bottom of the RTMS inner vessel.

In at least one example, the heating devices are controlled by a temperature control system, which controls the heating devices to provide consistent heat at high enough temperatures to ensure the fuel salt remains in liquid form in the reactor system.

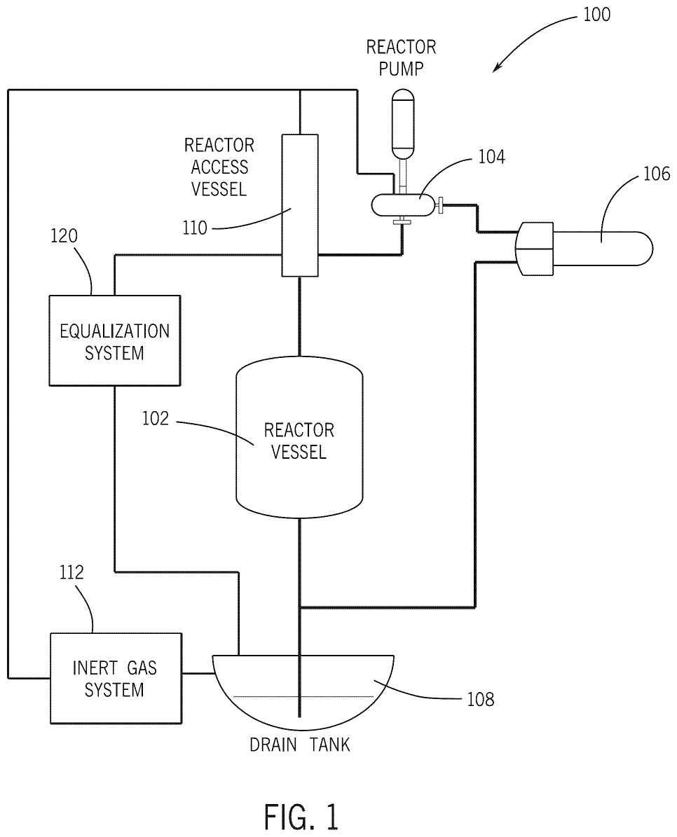

Turning to the Drawings, FIG. 1 depicts a schematic representation of an example molten salt reactor system 100. As will be understood, the example shown in FIG. 1 represents merely one example configuration of a molten salt reactor system 100 in which the RTMS and associated components may be implemented; in other examples, the RTMS may be implemented with substantially any other nuclear reactor system. The example molten salt reactor system 100 of FIG. 1 utilizes fuel salt enriched with uranium (e.g., high-assay low-enriched uranium) to create thermal power via nuclear fission reactions. In at least one example, the composition of the fuel salt may be LiF—BeF₂-UF₄, though other compositions of fuel salts may be utilized as fuel salts within the reactor system 100. The fuel salt within the system 100 is heated to high temperatures (such as 600° C. or greater) and melts as the system 100 is heated.

As shown in FIG. 1, the molten salt reactor system 100 includes a reactor vessel 102 where the nuclear reactions occur within the molten fuel salt, a fuel salt pump 104 that pumps the molten fuel salt to a heat exchanger 106, such that the molten fuel salt re-enters the reactor vessel after flowing through the heat exchanger 106, and piping in between each component. The molten salt reactor system 100 may also include additional components, such as, but not limited to, drain tank 108 and reactor access vessel 110. The drain tank 108 may be configured to store the fuel salt once the fuel salt is in the reactor system 100 but in a subcritical state, and also acts as storage for the fuel salt if power is lost in the system 100. The reactor access vessel may be configured to allow for introduction of small pellets of uranium fluoride (UF₄) to the system 100 as necessary to bring the reactor to a critical state and compensate for depletion of fissile material.

In several examples, the molten salt reactor system 100 may include an inert gas system 112 to provide inert gas to a head space of the drain tank 108, among other functions. The inert gas system 112 may further relieve inert gas from the head space of the drain tank 108 as needed. The inert gas system 112 is therefore operable to maintain pressurized inert gas in the head space of the drain tank 108 that is sufficient to substantially prevent the flow of molten fuel salt into the drain tank during normal operations (e.g., non-shutdown operations). For example, with the head space of the drain tank 108 pressurized by the inert gas system 112, molten salt may generally circulate between the reactor vessel 102 and the heat exchanger 106 without substantially draining into the drain tank 108. As described herein, the inert gas system 112 may be configured to supply inert gas to the head space of various other components of the molten salt reactor system 100, such as to the head space of the reactor access vessel 110, to the seal of reactor pump 104, among other components. Upon the occurrence of a shutdown event, the inert gas system 112 may cease providing inert gas to the head space of the drain tank 108, and other components to which the system 112 supplies inert gas.

The molten salt reactor system 100 may further include an equalization system 120 that is operable to equalize the pressure between the head space of the drain tank 108 and the reactor vessel 102 upon the occurrence of a shutdown event. For example, during normal operation a pressure differential exists between the head space of the drain tank 108 and the reactor vessel 102. Such pressure differential prevents or impedes the draining of the fuel salt into the drain tank 108. In this regard, the equalization system 120 may be operable to fluidically couple (via opening one or more valves) the head space of the drain tank 108 and the reactor vessel 102 to reduce or eliminate the pressure differential, thereby allowing the fuel salt to readily flow into the drain tank upon the shutdown event.

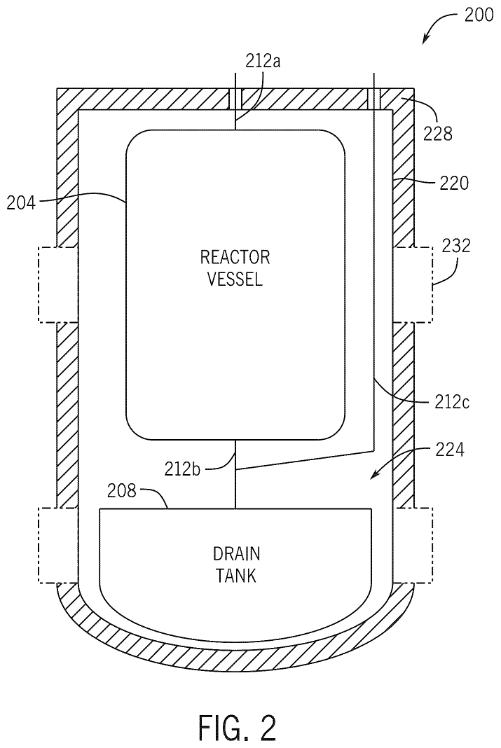

The RTMS disclosed herein may be used to maintain and/or control a temperature of one or more components of a molten salt nuclear reactor, such as any of the components shown in the system 100 of FIG. 1. With reference to FIG. 2, an example RTMS 200 is shown which is configured to maintain and/or control a temperature of a reactor vessel 204 and a drain tank 208. The reactor vessel 204 and the drain tank 208 may be substantially analogous to the reactor vessel 102 and the drain tank 108 described above in relation to FIG. 1; redundant explanation of which is omitted herein for clarity. For example, the reactor vessel 204 and the drain tank 208 may be tanks or vessels along a molten salt loop in which a heated molten salt is emitted from the reactor vessel at piping 212a, and recircuited to the reactor vessel 204 in cooled form via piping 212c and 212b.

The RTMS is shown in FIG. 2 as including an internal shield or vessel 220. The internal vessel 220 may be a thermally insulative metal (including certain stainless steels) that is capable of withstanding substantially high temperatures, such as temperature in excess of 600° C. The internal vessel 220 may surround the reactor vessel 204 and the drain tank 208 in order to define a first thermally insulative region 224 thereabout. The first thermally insulative region 224 may be a region of the reactor system that is generally maintained at a temperature that is sufficient to retain the molten salt of the molten salt loop in a molten state. Accordingly, a temperature of the first thermally insulative region 224 may, in certain cases, exceed 600° C. As described in greater detail herein, the internal vessel 220 may also serve as an additional containment barrier and catch-pan within which molten salt may be retained in the event of a leak event from any of the salt-bearing components that are held within the first thermally insulative region 224.

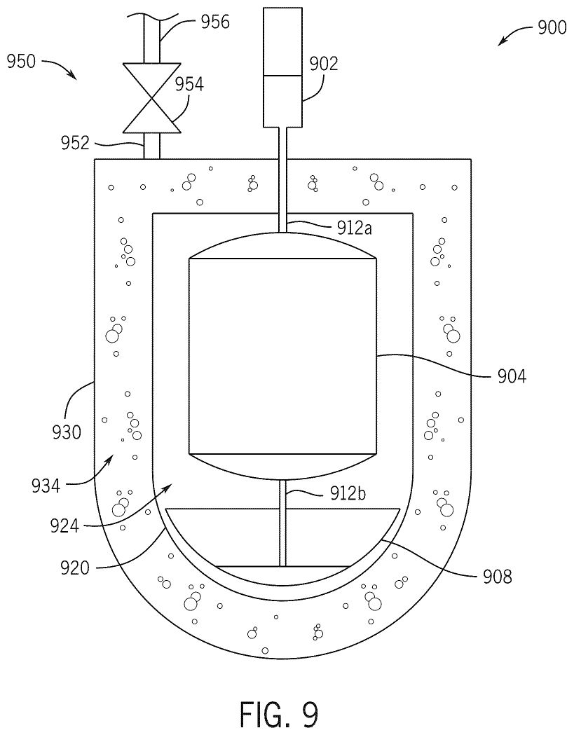

The RTMS 200 is further shown in FIG. 2 as including an insulative layer 228. The insulative layer 228 may be associated with and connected to the internal vessel 220 in order to facilitate the retention of heat within the first thermally insulative region 224. The insulative layer 228 may further be configured to establish a barrier between the first thermally insulative region 224 and components outside of the RTMS 200 (such as the concrete trench, structural steel, and so on), which may generally require lower temperatures to safely operate and perform the intended function of the component. In the example of FIG. 2, the insulative layer 228 may be formed from a polytetrafluoroethylene material. In other examples, other appropriate insulative materials could be used, including defining the insulative layer as inert gas kept under a vacuum, as described in greater detail herein with reference to FIG. 9.

FIG. 2 further shows optional heaters 232. The heaters 232 may be resistance heaters that are thermally coupled with the internal vessel 220 or that are otherwise configured to impart thermal energy to the first thermally insulative region 224. In this regard, in operation, the heaters 232 may be used to control a temperature of the first thermally insulative region 224. For example, the heaters 232 may be used to heat the first thermally insulative region 224 where the temperature of the first thermally insulative region 232 drops below a threshold temperature. The heaters 232 may therefore operate to retain the first thermally insulative region 224 at a temperature that allows the molten salt to remain in a molten state. This may be advantageous, for example, where the internal vessel 220 is used to catch molten salt from a leak event, and the heaters 232 operate to impart thermal energy to the first thermally insulative region 224 sufficient to maintain the leaked molten salt in a molten state within the catch pan or bottom of the internal vessel 220.

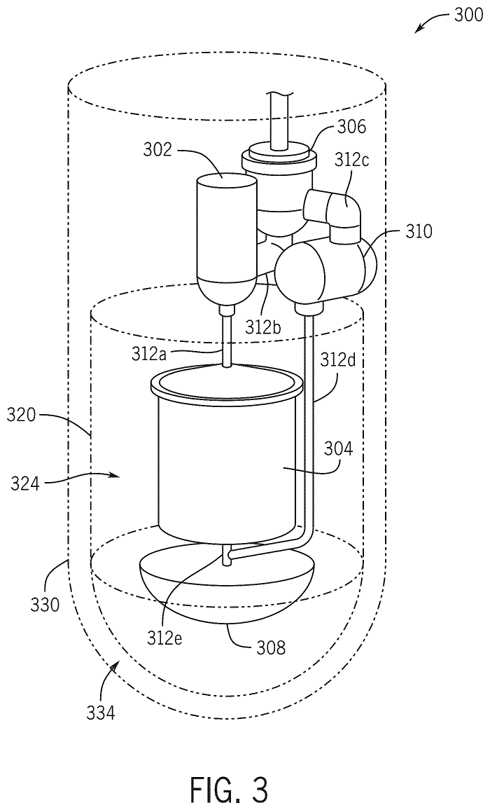

The RTMS's of the present disclosure may further include and be associated with a reactor enclosure that surrounds the internal shield and other salt-bearing components of the molten salt loop. In this regard, with reference to FIG. 3, a system 300 is shown including a molten salt loop having a reactor vessel 304, a drain tank 308, a reactor access vessel 302, a reactor pump 306, a heat exchanger 310, and piping 312a, 312b, 312c, 312c, 312d, 312e, which may be substantially analogous to like components described above in relation to FIG. 1. Further, the system 200 is shown as including an internal vessel or shield 320 that defines a first thermally insulative region 324, each of which may be substantially analogous to like components described above in relation to FIG. 2.

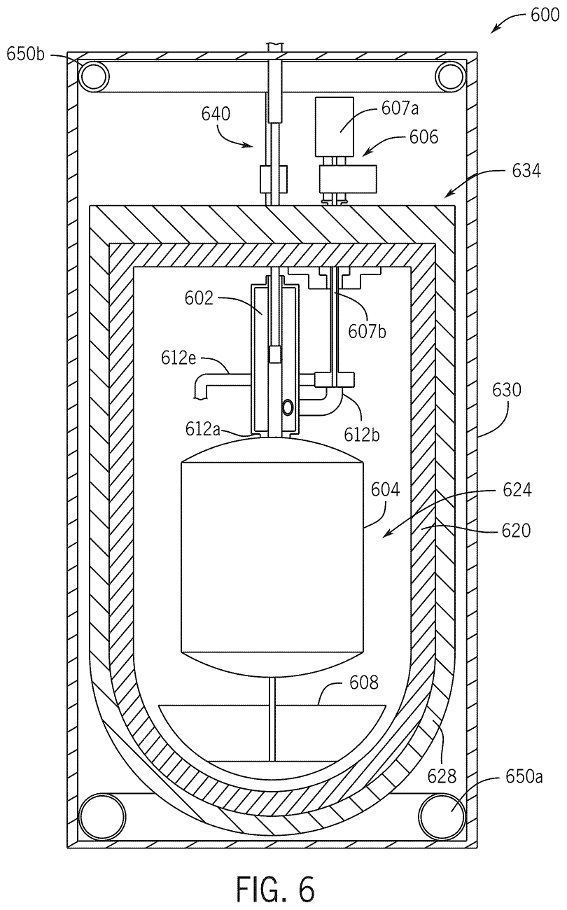

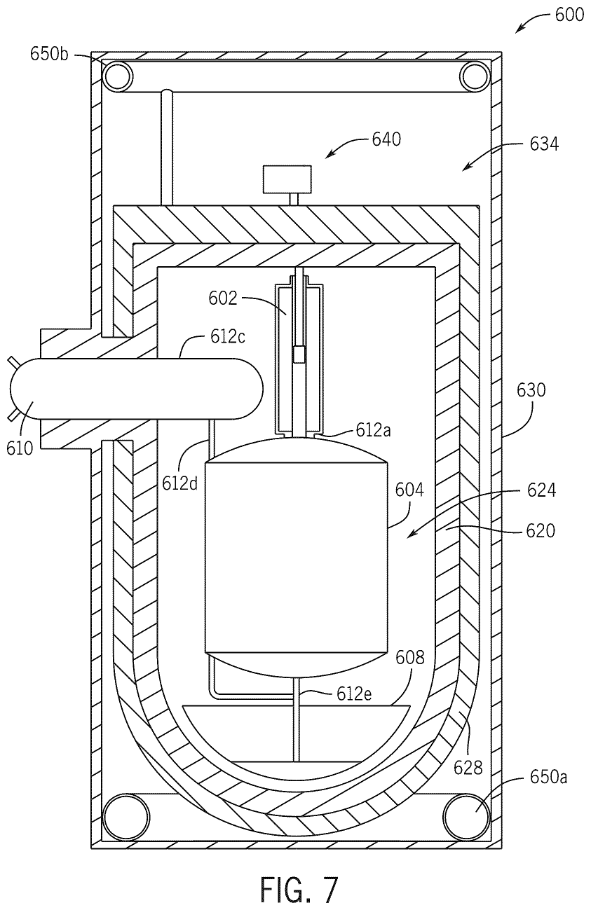

Notwithstanding the foregoing similarities, the system 300 is shown in FIG. 3 as including a reactor enclosure 330. The reactor enclosure 330, similar to the internal vessel or shield, may be constructed from a thermally insulative metal (including certain stainless steels) that is capable of withstanding substantially high temperatures, such as temperature in excess of 600° C. The reactor enclosure 330 is shown, schematically, as encompassing the entirety of the internal shield 320 and any other salt-bearing components that are not otherwise included with the internal shield 320. For example, the reactor enclosure 330 may define a second thermally insulative region 334 that receives the internal shield 320 and all the salt-bearing components that are not held within the first thermally insulative region 324. Accordingly, the second thermally insulative region 334 may be maintained or controlled to have a temperature that is different than a temperature of the first thermally insulative region 224, such as having a lower temperature. This may allow the system 300 to retain some of the salt-bearing components at a first temperature (e.g., the reactor vessel 304 and the drain tank 308), and separately maintain other salt-bearing components at a second temperature (e.g., the reactor access vessel 302, the pump 306, and the heat exchanger 310). Such arrangement may be advantageous where some of the salt-bearing components operate more efficiently at a lower or otherwise different temperature than a temperature of the reactor vessel 304, but are still required to be maintained at a substantially high enough temperature so as to retain the molten salt in molten form. As described in greater detail herein in relation to FIGS. 6 and 7, the various RTMS's disclosed herein may include any variation of salt-bearing components in the first thermally insulative region 324 versus the second thermally insulative region 334, including examples in which substantially all of the salt-bearing components are held within the first thermally insulative region 324. Further, and as will be appreciated from FIG. 3, the reactor enclosure 330 itself may serve as another containment barrier that is capable of holding a volume of molten salt in response to a leak event.

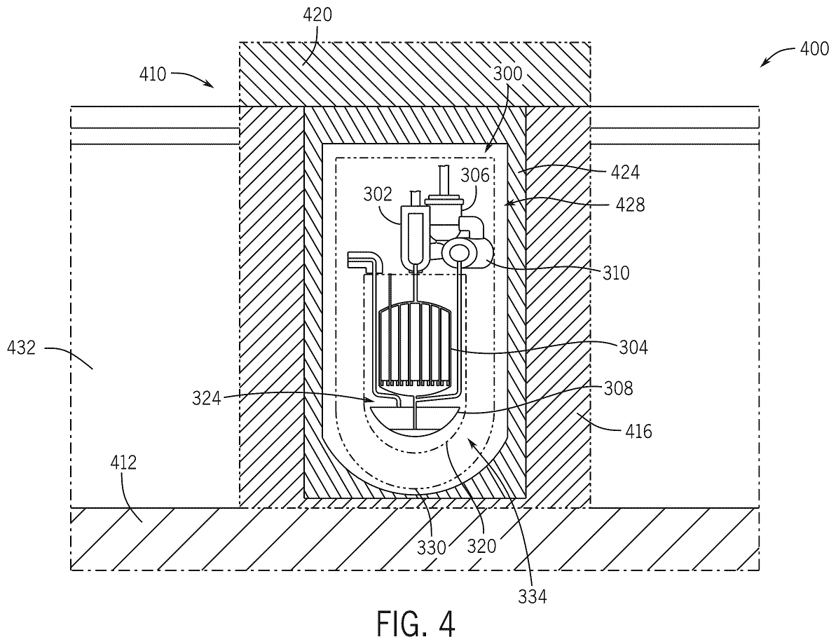

With reference to FIG. 4, the system 300 is shown within a structure 400 that may be used to define an additional thermally insulative and containment barrier about the RTMS. For example, the structure 400 may be or include a portion of a concrete structure 410 that defines a foundation 412, walls 416, associated building structure 432, and a top piece 420. At least a portion of the foundation 412 and the walls 416 may define a trench or a third thermally insulative region 428 within with the reactor enclosure 330 may be arranged. The third thermally insulative region 428 may be configured to maintain and/or control a temperature about the reactor enclosure 330 that is different than, such as being lower than, a temperature in either of the second thermally insulative region 334 or the first thermally insulative region 324.

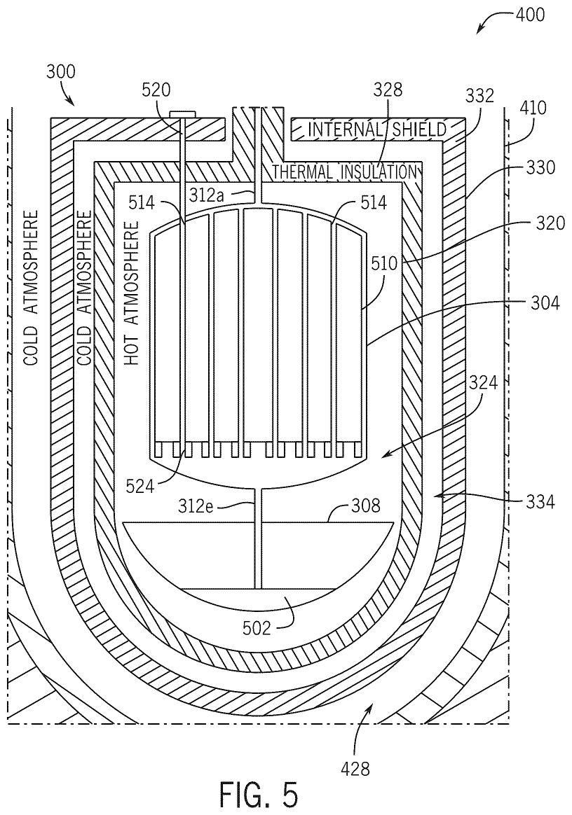

For example, and as illustrated in FIG. 5, a cross-sectional view of the system 400 is shown in which the first thermally insulative region 324 may be designated as a “hot atmosphere” in that a temperature in this region is sufficiently high to maintain all molten salt included therein in a molten state. The second thermally insulative region 334 may be designated as a “cold atmosphere” in that it has a temperature that is generally lower than the first thermally insulative region 324. Further, the third thermally insulative region 428 may also be designated as a “cold atmosphere” in that it has a temperature that is generally lower than each of the first thermally insulative region 324 and the second thermally insulative region 334. In some cases, the RTMS may operate to maintain and/or control a temperature of the third thermally insulative region 428 to at or below a temperature that is suitable for the operation and/or integrity of certain components of the system, such as by maintaining a temperature of the third thermally insulative region 428 at or below a temperature that would otherwise cause mechanical weakness of the concrete or structural steel included therein. As shown in FIG. 5, to facilitate the foregoing, the RTMS may include an internal shield 332 associated with or included within the reactor enclosure 330.

For purposes of illustration, FIG. 5 further shows graphite moderator 510 within the reactor vessel 304 that define flow channels 514 for a molten salt 502. The reactor vessel 304 is also shown with the moderator 510 defining a control rod channel 524 for receipt of a control rod therein. In operation, molten salt 502 may circulate through the reactor vessel 304 and associated molten salt loop as described herein. FIG. 5 shows a quantity of the molten salt 502 included within the drain tank 308. The RTMS 300 may operate to optionally maintain the molten salt 502 in a molten form for a period of time, despite the molten salt 502 being subcritical and being held in the drain tank 308. For example, the RTMS 300 may define the various thermally insulative barriers described herein so as to maintain the molten salt 502 in a molten state for a period time. This may allow the system to recirculate the molten salt and/or otherwise move the molten salt for repair, replacement, or operation of the reactor with greater efficiency and safety.

As described herein, the RTMS's of the present disclosure may be configured to surround and thermally insulate at least the molten salt reactor vessel and another component (e.g., a “second component,” such as a drain tank) that is fluidically coupled with the molten salt reactor vessel. For example, and as described above, the RTMS is shown including an internal vessel or internal shield that surrounds the molten salt reactor vessel and the drain tank (e.g., the second component). In other examples, the RTMS of the present disclosure may be configured to surround additional components of the molten salt loop including, without limitation some or all of a reactor access vessel, a reactor pump, a heat exchanger, and associated piping of the molten salt loop that fluidly couples said components to one another to form a continuous fluid circuit. In this regard, in FIGS. 6 and 7, another example of a RTMS is shown, a RTMS 600, in which the RTMS 600 surrounds such additional salt-bearing components of the molten salt loop.

By way of particular example, and with continued reference to FIGS. 6 and 7, the RTMS 600 is shown including an internal vessel or shield 620 and thermal insulation layer 628 that defines a first thermally insulative region 624 and a reactor enclosure 630 (having structural supports 650a, 650b), and that defines a second thermally insulative region 634. The RTMS 600 is shown with the internal shield 620 defining the first thermally insulative region 624 about all or a majority of the salt-bearing components of the molten salt loop, including a reactor vessel 604, a drain tank 608, a reactor access vessel 602, a reactor pump 606, a heat exchanger 610, and associated piping of the molten salt loop, piping 612a, 612b, 612c, 612d, 612e. In this regard, the RTMS 600 may operate to maintain or control a temperature of the first thermally insulative region 624 in order to facilitate keeping each of the reactor vessel 604, the drain tank 608, the reactor access vessel 602, the reactor pump 606, and the heat exchanger 610 at or above a temperature in which molten salt remains in molten form, including keeping such components at a temperature in excess of 600° C.

The RTMS 600, as further shown in FIGS. 6 and 7, may be further configured to permit some portion of the components of the molten salt loop system to be positioned at least partially outside of the first thermally insulative region 624, as may be appropriate for a given heat service of certain components. As one example, the reactor pump 606 is shown as including a pump motor 607a and a pump impeller 607b. The pump motor 607a may be arranged outside of the first thermally insulative region 624 (i.e., the pump motor 607a is arranged in the second thermally insulative region 634), which may be beneficial, for example, where the pump motor 607a operates more efficiently in a cooler environment that may otherwise be present in the first thermally insulative region 624. In turn, the pump impeller 607b may be operatively coupled with the pump motor 607a and extend fully into the first thermally insulative region for coupling with the molten salt flow therein. As another example, a fuel loading system 640 is shown that may be used to introduce uranium pellets and/or other materials to the molten salt of the molten salt loop via the reactor access vessel 602. The fuel loading system 640 is shown arranged outside of the first thermally insulative region 624 (i.e., the fuel loading system 640 is arranged in the second thermally insulative region 634), which may be beneficial, for example, where the fuel loading system 640 requires a lower operating temperature (as compared to the temperature of the first thermally insulative region 624) within which to introduce the material, which may be solid form, to the molten salt loop. Further, in some cases, a portion of the heat exchanger 610 may protrude from the first thermally insulative region 624 (and the second thermally insulative region 634), as shown in FIG. 7, in order to fluidly couple the heat exchanger 610 to coolant lines of the molten salt reactor system.

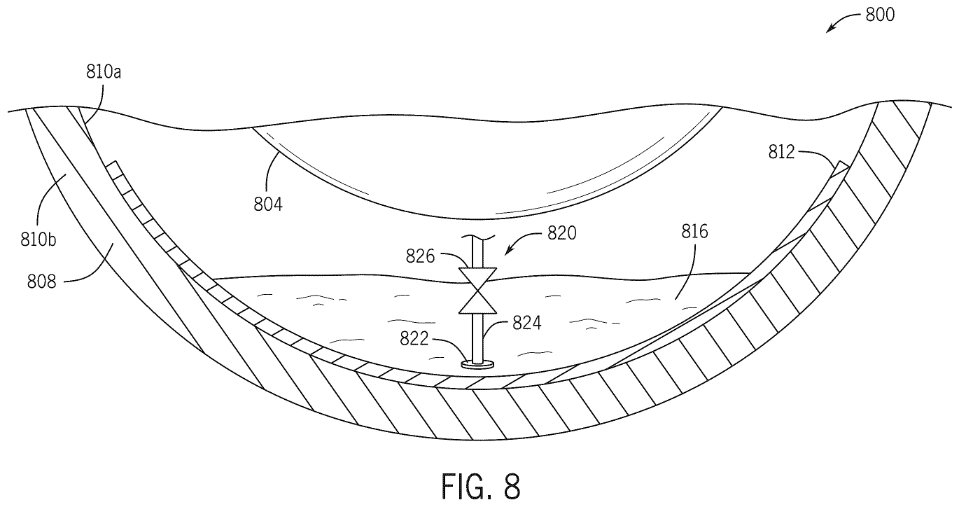

Turning to FIG. 8, a schematic view of a bottom portion of an example RTMS 800 is shown. The RTMS 800 is shown as being capable of holding a quantity of molten salt 816 that could be emitted from the molten salt system on the occurrence of a leak event. Because the RTMS 800 is capable of holding a quantity of molten salt 816, the RTMS 800 may be a passive safety system that prevents the release of molten sat 816 during an emergency. In this regard, FIG. 8 shows the system 800 as including a drain tank 804 and an internal shield or vessel 808. On the occurrence of a leak event or other emergency, molten salt, such as that which could be emitted from the drain tank 804 and/or other salt-bearing component of the molten salt loop, is collected by a bottommost surface of the internal vessel 808, thereby allowing the molten salt 816 to pool at the bottom of the internal vessel 808, as shown in FIG. 8.

The RTMS 800 may, in some cases, include various additional components to facilitate the collection and capture and subsequent processing of any molten salt 816 that is captured by the internal shield or vessel 808. For example, the RTMS 800 may include a liner 812 that is associated with and coupled to an inner surface 808a of the internal vessel 808. The liner 812 may be constructed from an impermeable and/or corrosion resistant material, including being constructed from certain synthetic or/or composite materials, that allows the molten salt 816 to pool within the curvature of the internal shield or vessel 808 without contacting the material of the internal vessel 808. Additionally or alternatively, the liner 812 may be a formed from a sacrificial metal. The liner 816 may therefore operate to support the containment of the molten salt 816 within the RTMS. The liner 812 may be generally thinner than a thickness of the internal shield 808 (e.g., a thickness defined between the inner surface 808a and an outer surface 808b of the internal shield 808); however, in other cases, the liner 812 may have a comparable thickness or a greater thickness as compared to the thickness of the internal shield 808, as appropriate for a given application.

The RTMS 800 is further constructed to optionally permit the capture of, and potential recirculation of, the molten salt 816 with the molten salt loop. As described herein in relation to FIG. 2, the RTMS's of the present disclosure may include one or more heaters to impart heat to the first thermally insulative region of the RTMS in order to maintain the molten salt at a temperature above which the molten salt would otherwise freeze. Accordingly, in one example, the molten salt 816 shown in FIG. 8 may be collected by the liner 812 and the internal vessel 808 and remain in substantially molten form therein due to a temperature of the first thermally insulative region remaining at or above a freezing temperature of the molten salt 816. In this regard, the RTMS 800 may include a recirculation system 820 that allows for the collection of the molten salt 816 from the liner 812 and internal vessel 808 and back into the molten salt loop, such as collecting molten salt 816 for reintroduction to the drain tank 804. To facilitate the foregoing, the RTMS 800 may include an entry port 822, a flow line 824, and a valve 826. The entry port 822 may be a flange or other port that is disposed generally near a bottom of the pool defined by the molten salt 816 held below the drain tank 804. The flow line 824 may extend from the entry port 822 and include the valve 824. The valve may be operated to permit a flow of the molten salt 816 to the molten salt loop in order to remain the molten salt 816 from the liner 816 and internal vessel 808 below.

Turning to FIG. 9, a cross-sectional view of another example RTMS is shown, a RTMS 900, in which an inert gas insulating layer is used to provide a thermally barrier during operation of a molten salt reactor 904. The inert gas may be held under vacuum, and on shutdown of the molten salt reactor 904, the inert gas can be released in order to reduce the thermally insulative properties of the RTMS 900, which may in turn support decay heat removal from the molten salt contained therein. To facilitate the foregoing, the RTMS 900 is shown as including an internal shield or vessel 920 that defines a first thermally insulative region 924 about the molten salt reactor 904, a drain tank 908, and piping 912a, 912b. A reactor access vessel 902 is shown outside of the first thermal insulative region 924. It will be appreciated that more or fewer salt-bearing components of the molten salt reactor loop may be arranged within the first thermally insulative region 924, as may be appropriate for a given application.

The RTMS 900 is further shown as including an outer vessel 930 that defines a second thermally insulative region 934 about the internal vessel 920. The second thermally insulative region 934 may include an inert gas, such as helium, that is held under vacuum during operation of the molten salt reactor 904. Holding the inert gas under vacuum may provide thermally insulative properties to the first thermally insulative region 924 that support the maintenance of the first thermally insulative region 924 at a temperature above the melting temperature of the molten salt. On a shut down event, it may be desirable to reduce the thermally insulative properties of the second thermally insulative region 934 in order to support the propagation of decay heat away from the molten salt and other salt-bearing components of molten salt loop. Accordingly, on shut down and/or an emergency event which requires that operation of the molten salt reactor 904 cease, the vacuum of the second thermally insulative region 934 may be released. Releasing the vacuum may reduce the thermally insulative properties of the second thermally insulative region 934, thereby permitting decay heat to exit the RTMS 900 more readily. To facilitate the foregoing, in one example, the RTMS 900 is shown as including a relief assembly 950. The relief assembly 950 may include a flow line extending from, and fluidly coupled with, the inert gas of the second thermally insulative region 934. The flow line 952 may be further associated with a valve 954, which may be a fail-open valve, that leads to a vent 954. Accordingly, on loss of power or other event in which the molten salt rector 904 is shutdown, the fail-open valve 954 may open and cause the vacuum to be relieved via fluid communication with the vent 954.

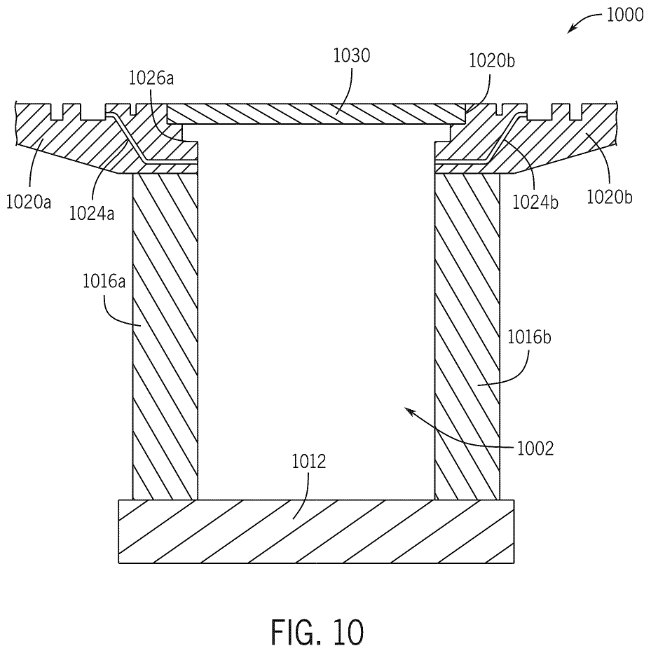

Turning to FIG. 10, a concert structure 1000 is depicted including a trench 1002 for enclosure of any of the molten salt systems and RTMS described herein. The example concrete structure 1000 is shown as including a foundation 1012 and walls 1016a, 1016b that define the trench 1002. Angled transition pieces 1020a, 1020b may extend from either top end of the walls 1016a, 1016b and establish respective lips 1026a, 1026b on which a top piece 1030 may rest. The top piece 1030 may enclose the trench 1002 and the RTMS and associated molten salt reactor components held therein. In some cases, passages 1024a, 1024b may be defined through the respective angled transition pieces 1020a, 1020b in order to allow for a flow of air into the trench 1002.

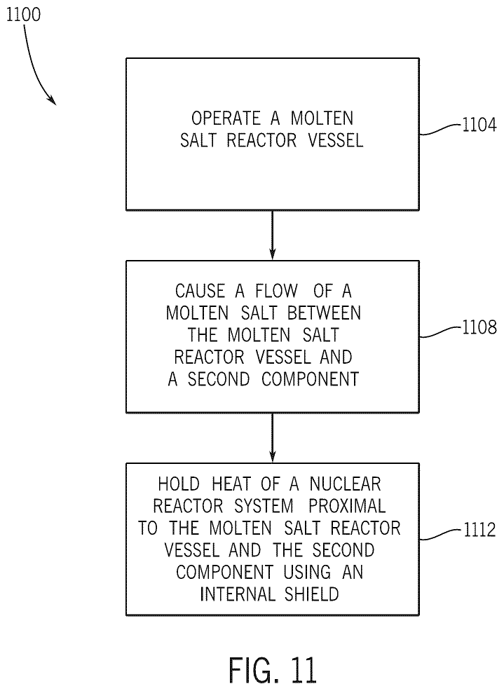

FIG. 11 depicts a flow diagram of an example method 1100 of maintaining a temperature of molten salt holding components of a nuclear reactor system. At operation 1104, a molten salt reactor vessel is operated. For example, and with reference to FIGS. 3-5, molten salt may be circulated through a molten salt loop and caused to undergo fission reactions in a reactor vessel 304. The fission reactions may heat the molten salt, which heat is extracted at the heat exchanger 310.

At operation 1108, a flow of a molten salt is caused between the molten salt reactor vessel and a second component. For example, and with continued reference to FIGS. 3-5, the molten salt is caused to flow along the molten salt loop. For example, the reactor pump 306 may operate to cause a flow of the molten salt from the reactor vessel 304 to circulate between the reactor vessel 304 and the heat exchanger 310 at which said heat is extracted. The molten salt should remain at or above a temperature during such circulation which would otherwise cause the molten salt to freeze.

At operation 1112, heat of a nuclear reactor system is held proximal to the molten salt reactor vessel and the second component using an internal shield. For example, and with continued reference to FIGS. 3-5, the RTMS 300 may operate to hold heat of the molten salt system proximal to the salt-bearing components of the molten salt loop in order to retain such components at or above a freezing temperature of the molten salt. For example, the internal shield or vessel 320 may surround at least the reactor vessel 304 and a second component (e.g., the drain tank 308) and define the first thermally insulative region 324 therearound at which the temperature is maintained at or above the freezing temperature of the molten salt. Further, the reactor vessel 330 may define the second thermally insulative region 334 about the internal shield or vessel 320 and some or all of the remaining salt-bearing components of the molten salt system.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1-20. (canceled)

21. A system comprising
a concrete trench;
a reactor vessel comprising a graphite reactor core, wherein the reactor vessel supports a circulated flow of fuel salt through the graphite reactor core along an internal flow path that causes fission reactions and heats the fuel salt therein;
a molten salt pump operatively coupled with the reactor vessel and configured to induce said circulated flow; and
a thermal barrier positioned about the reactor vessel,
wherein the reactor vessel, molten salt pump and thermal barrier are fully enclosed within the concrete trench.

22. The system of claim 21, wherein the thermal barrier is configured to maintain a region about an exterior surface of the reactor vessel at a temperature greater than a temperature of at least a portion of the molten salt pump.

23. The system of claim 22, wherein the molten salt pump comprises a pump motor positioned outside of the thermal barrier and a pump impeller positioned at least partially within the region.

24. The system of claim 23, further comprising a fuel loading system configured to introduce additional fuel to the reactor vessel.

25. The system of claim 24, wherein the fuel loading system is disposed at least partially outside of the thermal barrier.

26. The system of claim 25, further comprising a control rod, the control rod being selectively lowerable relative to the circulated flow of the fuel salt to alter said fission reactions occurring therein.

27. The system of claim 26, wherein the control rod is selectively lowerable through the thermal barrier.

28. The system of claim 27, wherein the thermal barrier is defined by an internal shield or vessel.

29. The system of claim 28, further comprising a reactor enclosure encompassing the reactor vessel and the thermal barrier, and being fully enclosed within the concrete trench.

30. The system of claim 29, wherein the reactor and the internal shield or vessel cooperate to maintain an inert environment held under a vacuum therebetween.

31. The system of claim 21, wherein the concrete trench defines a series of passages that permit a flow of air into the concrete trench.

32. The system of claim 31, wherein the concrete trench comprises a series of angled transition pieces disposed along an upper periphery of the concrete trench, and wherein said series of passages are defined through respective angled transition pieces of the series of angled transition pieces.

33. A method comprising
generating, using the system of claim 21, heat from said fission reactions; and
maintaining, using the thermal barrier, a region about an exterior surface of the reactor vessel at a temperature greater than a temperature of at least a portion of the molten salt pump.

34. The method of claim 33, further comprising permitting a flow of air into the concrete trench using a series of passage defined therethrough.

35. The method of claim 33, wherein
the system further comprises a fuel loading system disposed at partially outside of the thermal barrier, and
the method further includes introducing additional fuel to the reactor vessel using the fuel loading system.

36. The method of claim 35, wherein
the system further comprises a control rod, and
the method further comprises selectively lowering the control rod through the thermal barrier and relative to the circulated flow of the fuel salt to alter said fission reactions occurring therein.

37. A system comprising
a first thermally insulative region defined about a plurality of molten fuel salt bearing component by an internal shield, the plurality of molten salt bearing components comprising
a reactor vessel including a circulated flow of fuel salt,
a heat exchanger, and
a portion of a molten salt pump;
a control rod extending through the internal shield for selective lowering into the reactor vessel relative to the circulated flow of fuel salt; and
a second thermally insulative region defined about the internal shield and a portion of the control rod by a reactor enclosure, the second thermally insulative region being held at a temperature that is cooler than a temperature of the first thermally insulative region.

38. The system of claim 37, further comprising a third thermally insulative region defined about the reactor enclosure by a concrete trench, the third thermally insulative region being help at a temperature that is cooler than a temperature of the first thermally insulative region.

39. The system of claim 38, further comprising a graphite core within the reactor vessel.

40. The system of claim 39, wherein the concrete trench is configured to permit a flow of air into the third thermally insulative region.
